(19) United States
(12) Patent Application Publication
(10) Pub. No.: US 2017/0211726 A1
(43) Pub. Date: Jul. 27, 2017

(54) Flexible Hose Structure

(71) Applicant: Xiamen Tubetech Inc., Xiamen (CN)

(72) Inventors: Jianglin Yan, Xiamen (CN); Renping Li, Xiamen (CN); Jinjie Ye, Xiamen (CN)

(21) Appl. No.: 15/190,199

(22) Filed: Jun. 23, 2016

(30) Foreign Application Priority Data
Jan. 25, 2016 (CN) 201620068413.8

(51) Int. Cl. F16L 11/20; F16L 11/04; F16L 21/00

(52) U.S. Cl. CPC F16L 11/20; F16L 21/00; F16L 11/04

(57) ABSTRACT

A flexible hose structure includes an inner pipe, outer pipe and joint sleeve, the outer pipe is put around the inner pipe, the inner pipe is an integrated hollow pipe, and a hollow portion thereof is formed into a water passage, wherein a textured nylon reinforcing layer and plastic layer are put around the inner pipe from inside to outside in sequence, a joint is formed on an end portion of the inner pipe by means of secondary injection molding, and the joint sleeve is put around the joint loosely. The present invention can strengthen the pressure bearing capacity and the corrosion resistance ability of the inner pipe effectively, and the joint formed on the end portion of the inner pipe by means of secondary injection molding further increases the coupling strength of the inner pipe.

### TECHNICAL FIELD OF THE INVENTION

The present invention relates to a water passage connecting hose, and more particularly to a hose with an improved structure.

### DESCRIPTION OF THE PRIOR ART

Hoses are mostly connected to the water passages of faucets, sanitary ware or shower devices. The hoses available in the current market are divided into single-layered hoses and double-layered hoses in terms of structure. One kind of conventional single-layered hose is shown in FIG. 1. One of Such kinds of hoses is usually made from harder plastics or polyethylene, which is not good in flexibility so that the flap is prone to bending die. In addition, there is no protection provided on the surface of the hose body such that it is susceptible to corrosion or damage, resulting in leak easily due to an external force to affect the pressure bearing capacity and shorten its use. One kind of commonly used double-layered hoses shown in FIG. 2 is formed by covering an inner pipe with an outer pipe, where the inner pipe is formed from material with a better flexibility such as silicone, ethylene propylene diene terpolymer (EPDM), polyethylene (PE) or nitrile rubber (NBR), while the outer pipe is adopted with a nylon or stainless steel braided pipe and adapted to protect the inner pipe and configured to tie in with the bending and rotation of the inner pipe. The double-layered pipe has a better pressure bearing capacity, but it is corroded and damaged easily under a humid environment and further to affect the inner pipe, causing the inner pipe to be unprotected and to be vulnerable to destruction caused by external force, resulting in water leakage.

### SUMMARY OF THE INVENTION

The object of the present invention is to provide a flexible hose, capable of improving the pressure bearing capacity and corrosion resistance ability, and further extending the use life.

To achieve the object mentioned above, the present invention proposes a flexible hose structure, including an inner pipe, outer pipe and joint sleeve, the outer pipe is put around the inner pipe, the inner pipe is an integrated hollow pipe, and a hollow portion thereof is formed into a water passage, wherein a textured nylon reinforcing layer and plastic layer are put around the inner pipe from inside to outside in sequence, a joint is formed on an end portion of the inner pipe by means of secondary injection molding, and the joint sleeve is put around the joint loosely.

Furthermore, an outward rewound folding is formed on a mouth of the inner pipe before secondary injection molding.

A retaining edge is formed on the inner end of the joint sleeve, and a limit flange adapted to fit with the retaining edge is configured on the joint.

The outer pipe is adopted with a stainless steel double-fastening structure.

A joint sleeve allowing the inner pipe to be in embedded fit with the outer pipe is further configured between the end portions of the inner pipe and outer pipe.

A clamping sleeve is covered on the outer rim of the end portion of the outer pipe.

The joint and joint sleeve are integrated into a connection head and formed on the end portion of the inner pipe by means of secondary injection molding.

The front end of the connection head is formed into a tapered conical bevel.

As mentioned above, the textured nylon reinforcing layer and plastic layer being put around the surface of the inner pipe can improve the pressure bearing capacity and the corrosion resistance ability of the inner pipe effectively, and the joint formed on the end portion of the inner pipe by means of secondary injection molding further increases the coupling strength of the inner pipe.

In addition, the joint sleeve embedded between the inner pipe and outer pipe and the structure of the joint being integrated with the joint to form into the connection head not only increases the coupling strength and improve the use life of the hose but also optimizes the integration of the components, simplifies the manufacturing and reduces the cost.

### BRIEF DESCRIPTION OF THE DRAWINGS

FIG. 1 is a schematic view of a conventional flexible hose;

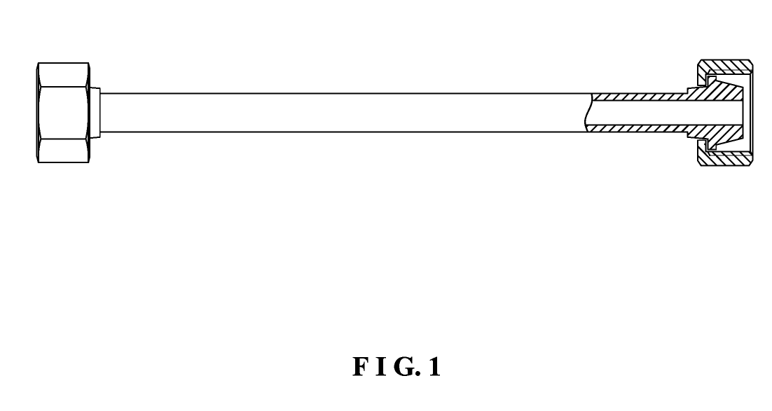

FIG. 2 is a schematic view of a conventional flexible hose of another structure;

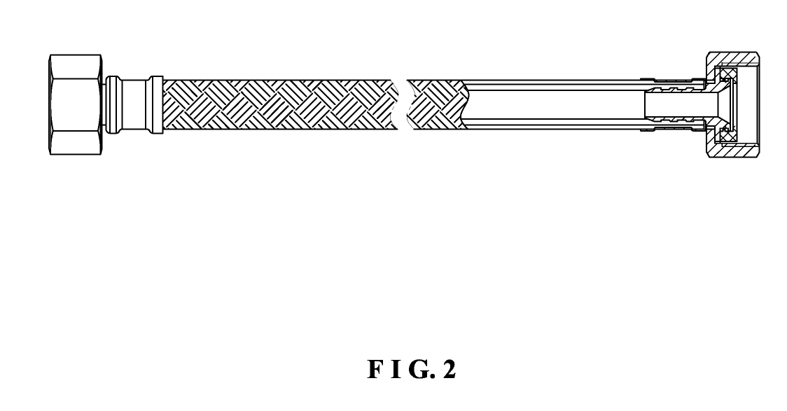

FIG. 3 is a cross-sectional view of a first preferred embodiment of the present invention;

FIG. 4 is a cross-sectional view of a second preferred embodiment of the present invention;

FIG. 5 is a cross-sectional view of a third preferred embodiment of the present invention; and

FIG. 6 is a cross-sectional view of a fourth preferred embodiment of the present invention.

### DETAILED DESCRIPTION OF THE PREFERRED EMBODIMENTS

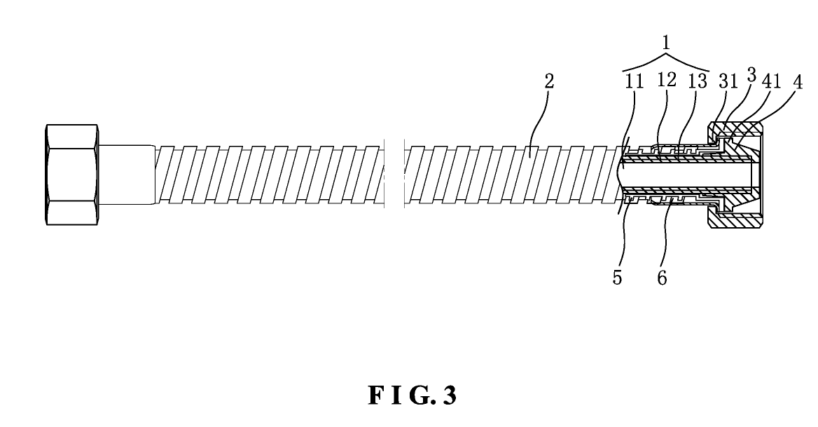

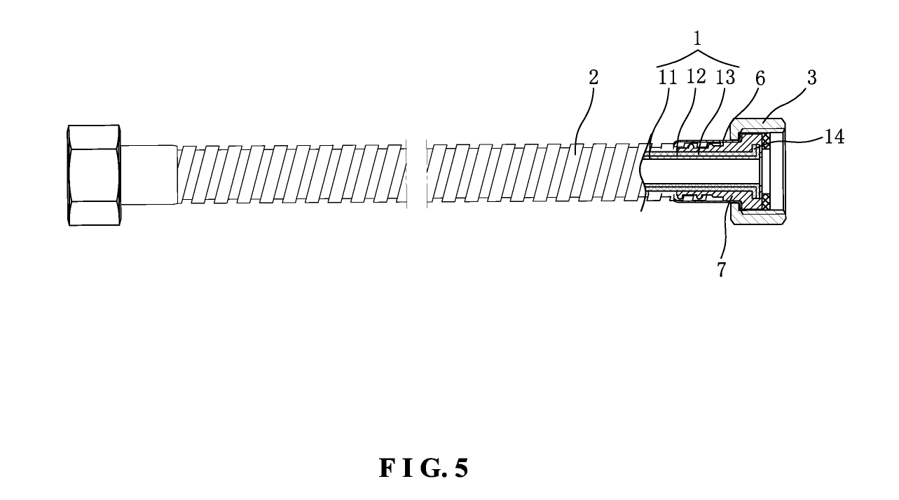

Referring to FIGS. 3 to 6, a flexible hose structure of the present invention includes an inner pipe 1, outer pipe 2 and joint sleeve 3. The inner pipe 1 is an integrated hollow pipe made from silicone or rubber, being flexible and bendable, where the hollow part thereof is formed into a water passage. Especially, the surface of the inner pipe is put around by a textured nylon reinforcing layer 12 and plastic layer 13 from inside to outside in sequence, thereby strengthening the inner pipe and improving the pressure bearing capacity of the inner pipe 1.

The end portion of the inner pipe 1 is configured with a joint 4 adapted to fit with the joint sleeve 3 by means of secondary injection molding. Furthermore, the outer pipe 2 is put around the inner pipe and adopted with a stainless steel double-fastening structure. Furthermore, the joint sleeve 3 is a hollow sleeve structure engaged loosely with the joint 4 and is configured on the end portion of the inner pipe 1. Furthermore, a retaining edge 31 is formed on the inner end of the joint sleeve 3, and a limit flange 41 adapted to fit with the retaining edge 31 is configured on the front end of the joint 4, thereby preventing the joint sleeve 3 from escaping from the joint 4.

A joint sleeve 5 allowing the inner pipe 1 to be in embedded fit with the outer pipe 2 is further configured between the end portions of the inner pipe 1 and outer pipe 2, and a clamping sleeve 6 is covered on the outer rim of the outer pipe 2 in such a way to increase the fit strength thereof and coupling strength of the end portion of the entire hose.

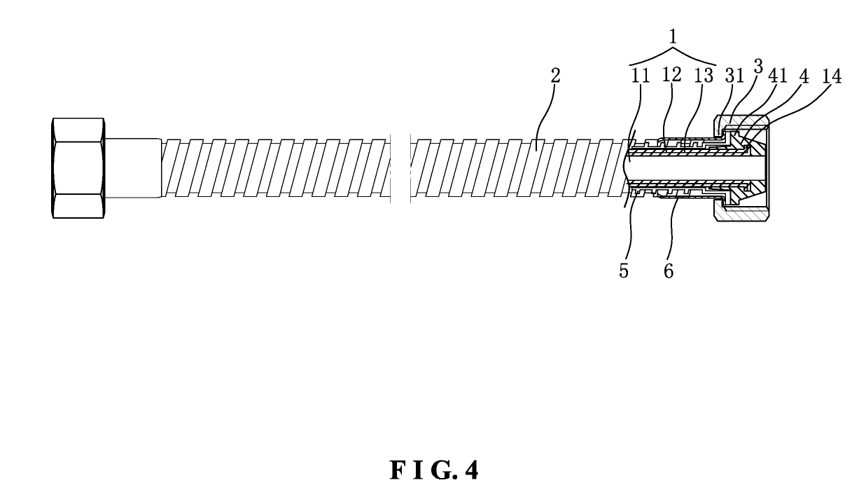

Referring FIG. 4, in a second preferred embodiment, an outward rewound folding 14 is further formed on the mouth of the inner pipe 1 before the secondary injection molding in such a way to increase the tensile strength, and further to stabilize the coupling of the inner pipe 1 to the joint 4.

In a third preferred embodiment, the joint 4 and joint sleeve 5, as FIG. 4 shows, may be integrated into a connection head 7, which is formed on the end portion of the inner pipe 1 by means secondary injection molding, and an outward rewound folding 14 is formed on the mouth of the inner pipe 1, with the front end of joint 4 being formed with an end face flush with the front end of the inner pipe 1 and being connected hermetically with a pipeline with the aid of a plain washer.

The inner pipe 1 may be processed by means of hot melting so as to allow the inner pipe 1 to have a better connection with the connection head 7 before the connection head 7 is integrated with the end portion of the inner pipe 1, thereby realizing a better coupling strength between the both.

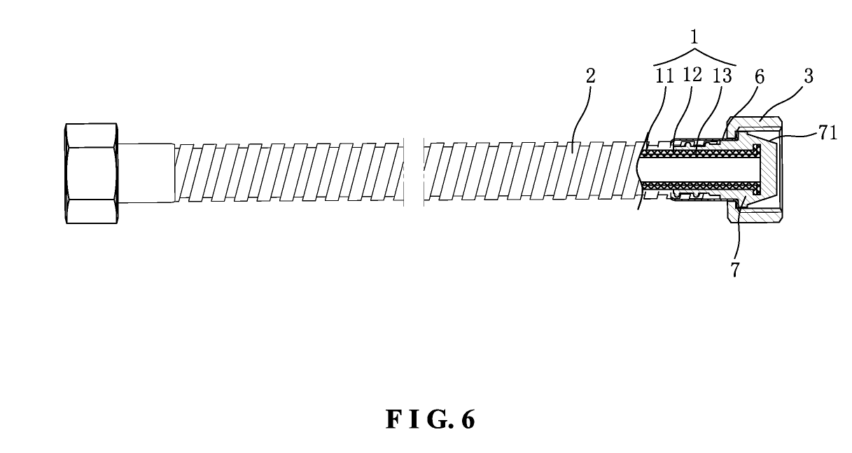

In a fourth preferred embodiment, in order to ensure a better sealability between the hose and a pipeline connected therewith, a tapered conical bevel 71, as FIG. 6 shows, is formed on the front end of the connection head 7, thereby being extended into the pipeline to achieve a compression seal effect.

To sum up, in the present invention, the textured nylon reinforcing layer 12 and plastic layer 13 being put around the surface of the inner pipe 1 can improve the pressure bearing capacity and the corrosion resistance ability of the inner pipe 1 effectively, and the joint 4 formed on the end portion of the inner pipe 1 by means of secondary injection molding further increases the coupling strength of the inner pipe 1. Furthermore, the joint sleeve 5 embedded between the inner pipe 1 and outer pipe 2 being integrated with the joint 4 to form into the connection head 7 not only increases the coupling strength and improves the use life of the hose but also optimizes the integration of the components, simplifies the manufacturing and reduces the cost.

I claim:

1. A flexible hose structure, comprising an inner pipe, outer pipe and joint sleeve, said outer pipe being put around said inner pipe, said inner pipe being an integrated hollow pipe, a hollow portion thereof being formed into a water passage, wherein a textured nylon reinforcing layer and plastic layer are put around said inner pipe from inside to outside in sequence, and a joint is formed on an end portion of said inner pipe by means of secondary injection molding, and said joint sleeve is put around said joint loosely.

2. The structure according to claim 1, wherein an outward rewound folding is formed on a mouth of said inner pipe before secondary injection molding.

3. The structure according to claim 1, wherein a retaining edge is formed on an inner end of said joint sleeve, and a limit flange fit with said retaining edge is configured on said joint.

4. The structure according to claim 1, wherein said outer pipe is adopted with a stainless steel double-fastening pipe structure.

5. The structure according to claim 1, wherein a joint sleeve allowing said inner pipe to be in embedded fit with said outer pipe is configured between end portions thereof

6. The structure according to claim 1, wherein a clamping sleeve is covered on an outer rim of an end portion of said outer pipe.

7. The structure according to claim 5, wherein said joint and joint sleeve are integrated into a connection head and formed on said end portion of said inner portion by means of secondary injection molding.

8. The structure according to claim 7, wherein a front end of said connection head is formed with a tapered conical bevel.
